(19) United States
(12) Patent Application Publication
(10) Pub. No.: US 2010/0283294 A1
(43) Pub. Date: Nov. 11, 2010

(54) VEHICLE ROOF COMPRISING A WIND DEFLECTOR

(75) Inventor: Oguzhan Gündogdu, Dachau (DE)

Correspondence Address: FITCH EVEN TABIN & FLANNERY, 120 SOUTH LASALLE STREET, SUITE 1600, CHICAGO, IL, 60603-3406, US

(73) Assignee: Webasto AG, Stockdorf (DE)

(21) Appl. No.: 12/305,831

(22) PCT Filed: Jun. 14, 2007
(86) PCT No.: PCT/DE2007/001057

§ 371 Date: Feb. 22, 2010

(30) Foreign Application Priority Data
Jun. 20, 2006 (DE) 10 2006 028 257.4

(51) Int. Cl. B60J 7/02

(52) U.S. Cl. 296/217

(57) ABSTRACT

The invention relates to a vehicle roof of a motor vehicle that is provided with a roof opening system comprising at least one cover element for selectively closing or at least partially opening a roof section. A wind deflector (20) is arranged in the front edge area (18) of the roof section, said wind deflector comprises a deflector element (22) that can be adjusted between a lowered idle state and an operational state and is pre-tensed in the direction of extraction. The extent of extraction can be adjusted by means of an adjusting device that comprises at least one flexible element (28A, 28B) which is fixed to a first end on the deflector element (22) and exerts a retaining force which is active in a downward manner on the deflector element (22). In order to provide a compact adjusting device having few components, the second end of the flexible element (28A, 28B) is mounted on the winding device, which is driven by means of an electric motor, on which the flexible element (28A, 28B) can be wound or the flexible element can be wound thereby.

The invention relates to a vehicle roof according to the pre-characterizing clause of claim 1.

A vehicle roof of this type is known from DE 102 32 917 A1 and comprises a roof opening system having a cover element which serves selectively to close or at least partially to release a roof opening. A wind deflector, which can be swiveled out of a lowered position and is pre-tensed in the direction of extraction, is arranged in the front edge region of the roof opening. The extent of extraction of this wind deflector can be varied by means of an adjusting device comprising a flexible element made of a wire or rope piece which is fastened at one end to the wind deflector and exerts a downwardly acting retaining force on the wind deflector. The flexible end is connected, at its end remote from the wind deflector, to a pliable shaft which is moved in a translatory manner for adjusting the wind deflector. The pliable shaft is moved by means of a servomotor. The adjusting device is arranged in the region of a frame front part of the roof opening system and requires the provision of a sufficiently large overall space in the vehicle longitudinal direction.

Furthermore, an adjustable wind deflector for a sliding roof system is known from DE 101 42 047 A1. An actuating element, consisting of a wire made of a shape memory alloy, is provided for adjusting the wind deflector. The wire, which exerts a retaining force on the wind deflector, changes its length as a function of its temperature, as a result of which the wind deflector is extracted or retracted. The temperature of the wire is altered by introducing a heating current into the wire.

The invention is based on the object of designing a vehicle roof of the type mentioned at the outset with a simple and compact adjusting device for a wind deflector.

According to the invention, this object is achieved by the vehicle roof having the features of claim 1.

The core of the invention accordingly consists in the fact that a winding device is provided for the flexible element which serves as a means for holding down the wind deflector and defines the extent of extraction of the wind deflector which is generally pre-tensed in the direction of extraction. A winding device of this type can be accommodated compactly in the region of a frame front part of a sliding roof frame. The winding device for the flexible element, which is a traction device, can be produced using few components. All that are required are a winding body and the drive, formed by the electric motor, for the winding body.

In the case of a preferred embodiment of the vehicle roof according to the invention, the winding device is formed by a shaft which extends in the vehicle transverse direction and can be driven by means of the electric motor for winding or unwinding the flexible element and can be embodied in a flexible or rigid manner.

Expediently provided in both lateral end regions of the wind deflector or of the deflector element forming the flow surface are flexible elements which can each be wound on a common shaft or unwound therefrom and thus define the extent of extraction of the wind deflector or of the deflector element as a function of the degree of winding.

In order to ensure precise winding or unwinding of the flexible element on or from the winding device, guide devices for the flexible element, which preferably laterally guide the flexible element, can be arranged on the shaft.

The flexible element is formed for example from a tape, such as a fabric tape, a rope, a wire, or another element which can be wound onto a winding device.

In order to be able to carry out compact and overall space-optimized integration of the adjusting device embodied in accordance with the invention, the flexible element is preferably diverted at least by a diversion device. The diversion device can be formed by a roller. For example, the winding device is positioned, viewed in the direction of travel, before the deflector element, i.e. in the region of a front cowl, wherein the flexible element is then diverted preferably on two diversion devices, in particular on two diversion rollers, in order to be able to exert a downwardly directed force component onto the deflector element.

In order to be able to define a maximum extent of extraction of the deflector element, there can be arranged on or at the flexible element a stop element which interacts for example with a counter stop formed by a structural element of a sliding roof frame.

In order to allow simple detachment of the wind deflector or the wind deflector blade, it is advantageous if the flexible element is detachably fastened to the wind deflector. This can be carried out for example by means of what is known as a keyhole system or a screw bolt.

The drive device for the flexible element, i.e. the electric motor, is actuated for example in an automated manner as a function of the speed of travel of the motor vehicle in question and/or else of the degree of opening of the cover element. It is also possible to provide a noise sensor which is coupled to a controller of the electric motor, thus allowing a low noise level to be attained even at relatively high speeds by appropriate setting of the adjusting device for the wind deflector. Alternatively, the electric motor for driving the shaft, which is preferably integrated into a frame front part of a sliding roof frame, can however also be activated manually by actuating a switch.

Further advantages and advantageous configurations of the subject-matter according to the invention may be inferred from the description, the drawings and the claims.

An exemplary embodiment of a vehicle roof which is designed in accordance with the invention and has an adjustable wind deflector will be described in greater detail in the subsequent description and is illustrated in a schematically simplified manner in the drawings, in which:

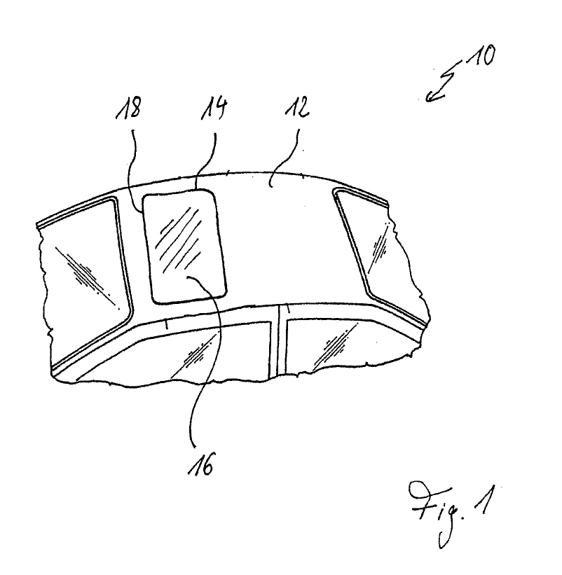

FIG. 1 is a perspective plan view onto a vehicle roof according to the invention;

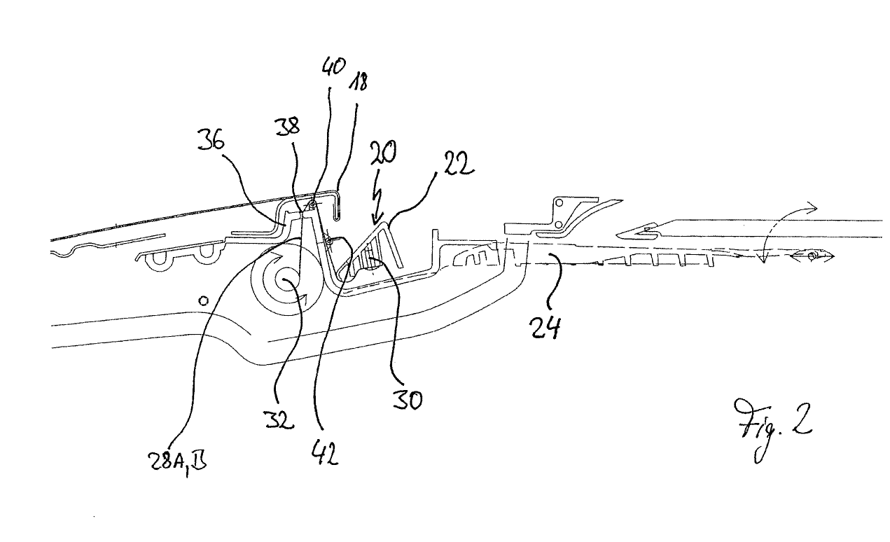

FIG. 2 is a longitudinal section through the vehicle roof according to FIG. 1 in the region of a wind deflector in the idle position thereof;

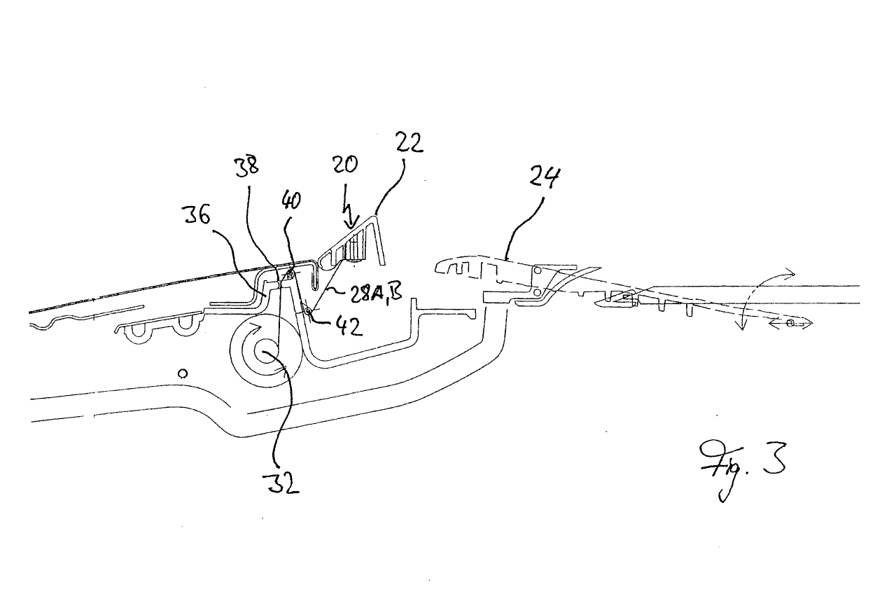

FIG. 3 is a view corresponding to FIG. 2, wherein the wind deflector assumes a first operational position;

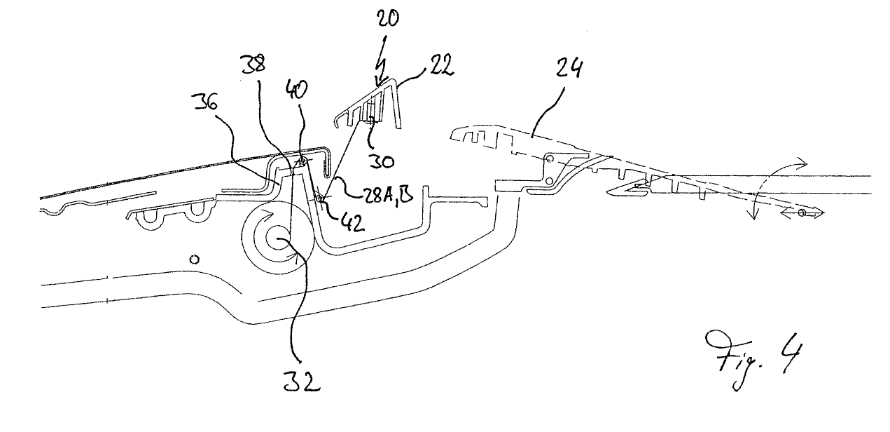

FIG. 4 is a view corresponding to FIG. 2, wherein the wind deflector assumes a second operational position; and

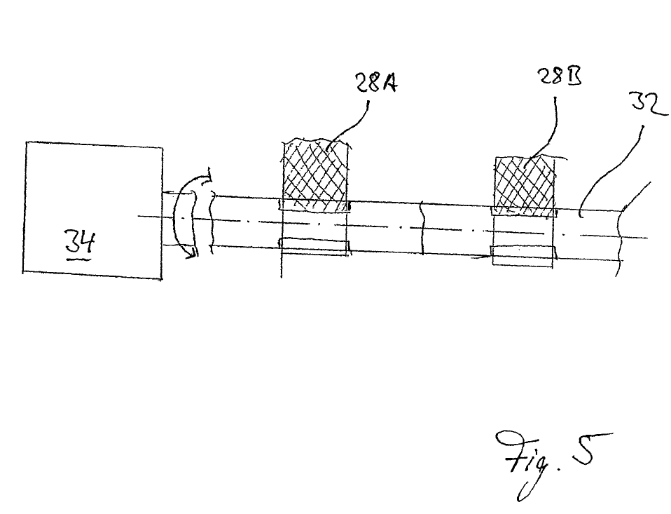

FIG. 5 is a detailed view of an adjusting device for the wind deflector.

FIG. 1 shows a motor vehicle 10 equipped with a vehicle roof 12 embodied in accordance with the invention. The vehicle roof 12 has a roof section 14 which can be selectively closed or at least partially released by means of a cover element 16.

For adjusting the cover element 16, a drive motor (not illustrated in greater detail in the present document) is provided and connected via compressionally rigid drive cables to drive carriages which are pivotably guided on both sides of the roof section 14 in guide rails of frame lateral parts of a sliding roof frame and are operatively connected in a known manner to the cover element 16. The direction of displacement of the cover element 16 in the guide rails corresponds to the longitudinal direction of the motor vehicle 10 equipped with the vehicle roof 12 embodied in accordance with the invention.

In order to prevent, when the roof section 14 is opened, disruptive air turbulences in the vehicle interior, a wind deflector 20, illustrated in particular in FIGS. 2 to 4, is arranged in the region of a front edge 18 of the roof section 14.

The wind deflector 20 has a deflector element or wind deflector blade 22 oriented substantially in the vehicle transverse direction and laterally a respective wind deflector arm 24 which is connected to the wind deflector blade 22 and is resiliently pre-tensed in the direction of extraction by means of an extraction spring (not illustrated in greater detail in the present document). During closing of the cover element 16, said element advances toward the wind deflector arms 24 from the rear, so that the wind deflector blade 22 is lowered counter to the force of the extraction springs acting on the wind deflector arms 24. In this way, in the closed position of the cover element 16, the wind deflector blade 22 is held, counter to the spring pre-tensing, in its idle position below the cover element 16. During opening of the cover element 16, the wind deflector arms 24 are on the other hand released, so that the wind deflector blade 22 can swivel upward owing to the spring force exerted by the extraction springs onto the wind deflector arms 24. The movement of extraction of the wind deflector blade 22 is delimited by an adjusting device 26 which will be described hereinafter in greater detail and acts on the two ends of the wind deflector blade 24 and accordingly delimits extraction.

The adjusting device 26 comprises two fabric tapes 28A and 28B which are detachably connected to the wind deflector blade 22, on both sides thereof and in the lateral end regions thereof, and exert a downwardly directed tensile force on the wind deflector blade 22. In the present exemplary embodiment, the fixing takes place in each case by means of a screw bolt 30. The fabric tapes 28A and 28B are mounted on a shaft 32 at their ends remote from the wind deflector blade 22. The shaft 32 forms a winding device for the fabric tapes 28A and 28B, each of which are a flexible element. The shaft 32, which is oriented in the vehicle transverse direction, can be driven by means of an electric motor 34 or forms the drive shaft of the electric motor 34, so that the fabric tapes 28A and 28B can each be wound onto the shaft 32 or unwound therefrom. The electric motor 34 is accordingly drivable in two directions of rotation and for this purpose connected to a motor controller (not illustrated in greater detail).

The shaft 32 is integrated, in a region arranged in the direction of travel before the front edge 18 of the roof section 14, into a frame front part 36 of a sliding roof frame. The fabric tapes 28A and 28B are each guided out of the frame front part 36 via a slot 38 and each diverted on two diversion rollers 40 and 42 and thus guided, at the end remote from the shaft 32, to the wind deflector blade 22.

The adjusting device 26, embodied in accordance with the invention, for the wind deflector 20 operates in the manner described hereinafter.

In the closed position or only slightly opened position of the cover element 16, said cover element presses onto the wind deflector arms 24, so that the wind deflector blade 22 is in the idle position which is illustrated in FIG. 2 and in which it is arranged below the front edge 18 of the roof section 14. This corresponds to the position of the wind deflector 20 that is illustrated in FIG. 2.

When the cover element 16 returns, i.e. the roof section 14 is opened further, the wind deflector arms 24 are released, and the wind deflector blade 22 swivels out into a first operational position illustrated in FIG. 3. The wind deflector blade 22 then forms an air flow surface. The extent of swiveling-out is delimited by the fabric tapes 28A, 28B which hold the wind deflector blade 22, counter to the spring force of the extraction springs acting on the wind deflector arms 24, in a respectively desired position.

The wind deflector blade 22 can then be extracted into the second operational position illustrated in FIG. 4 as a function of the speed of travel and/or the formation of noise. This is carried out by actuating the adjusting device 26, i.e. the electric motor 34, in such a way that the fabric tapes 28A, 28B are unwound from the shaft 32 and the wind deflector blade 22 is extracted further owing to the spring force of the extraction springs acting on the wind deflector arms 24. The operational position, which is then set, of the wind deflector blade 22 is illustrated in FIG. 4 in which the wind deflector blade 22 is underflowed.

In principle, the wind deflector blade 22 can be underflowed in any desired manner, in order to reduce noise, by winding or unwinding the flexible element which is embodied as a traction element.

If the extent of extraction of the wind deflector blade is to be reduced, the electric motor 34, and thus the shaft 32, is actuated in the opposite direction of rotation, so that the fabric tapes 28A and 28B are wound onto the shaft 32 and the wind deflector blade 22 is lowered.

### REFERENCE NUMERALS

10 Motor vehicle
12 Vehicle roof
14 Roof section
16 Cover element
18 Front edge
20 Wind deflector
22 Wind deflector blade
24 Wind deflector arm
26 Adjusting device
28A, 28B Fabric tapes
30 Screw bolt
32 Shaft
34 Electric motor
36 Frame front part
38 Slot
40 Diversion roller
42 Diversion roller

1. A vehicle roof, with a roof opening system, comprising: at least one cover element for selectively closing or at least partially releasing a roof section, comprising a wind deflector which is arranged in the front edge region of the roof section and comprises a deflector element which can be adjusted between a lowered idle state and an operational state and is pre-tensed in the direction of extraction, wherein the extent of extraction can be adjusted by means of an adjusting device having at least one flexible element which is fastened at a first end to the deflector element and exerts a downwardly acting retaining force on the deflector element, wherein the second end of the flexible element is mounted on a winding device which is driven by means of an electric motor and onto which the flexible element, can be wound or from which the flexible element can be unwound.

2. The vehicle roof of claim 1, wherein the winding device is formed by a shaft which extends in the vehicle transverse direction and can be driven by means of the electric motor for winding or unwinding the flexible element.

3. The vehicle roof of claim 2, wherein guide devices for the flexible element are arranged on the shaft.

4. The vehicle roof of claim 1, wherein the flexible element is formed from a fabric tape, a wire, a rope or the like.

5. The vehicle roof of claim 1, wherein the flexible element is diverted on at least one diversion device formed preferably by a roller.

6. The vehicle roof of claim 1, wherein the flexible element has a stop element which defines a maximum extent of extraction of the deflector element.

7. The vehicle roof of claim 1, wherein the flexible element is detachably fastened to the wind deflector blade.

8. The vehicle roof of claim 1, further comprising a vehicle speed-dependent activation of the electric motor.

9. The vehicle roof of claim 1, further comprising a noise sensor which is coupled to a controller of the electric motor.

10. The vehicle roof of claim 2, wherein the shaft is integrated in a frame front part of a sliding roof frame.
